(19) United States
(12) Patent Application Publication
(10) Pub. No.: US 2010/0036924 A1
(43) Pub. Date: Feb. 11, 2010

(54) System and method for providing electronic reminders

(76) Inventors: Loai Naamani, Boston, MA (US); Rabih Zbib, Cambridge, MA (US); Gus Souki, Cambridge, MA (US)

Correspondence Address: Rabih Zbib, Apt. #3, 3 Langdon Square, Cambridge, MA, 02138, US

(21) Appl. No.: 12/535,467

(22) Filed: Aug. 4, 2009

Related U.S. Application Data
(60) Provisional application No. 61/086,007, filed on Aug. 4, 2008.

(51) Int. Cl. G06F 15/16

(52) U.S. Cl. 709/206

(57) ABSTRACT

A system and method is disclosed for electronically registering an event and reminding interested persons of the said event. The system comprises a client device with means for entering and sending event information, a client device with means for expressing interest in an event and receiving a reminder message, a server system with means for communicating with the client devices, storing event information, scheduling reminders, and dispatching reminder messages, and a telecommunications network through which event information and reminder messages are transferred between the client devices and server system. The server system contains a software module that uses rules, heuristics, and statistical data to calculate reminder time when not explicitly specified by the reminder recipient. The disclosed invention handles any event with a predefined time and supports different electronic data types, client devices, client software applications, and communication protocols through which event information and reminder messages are transmitted.

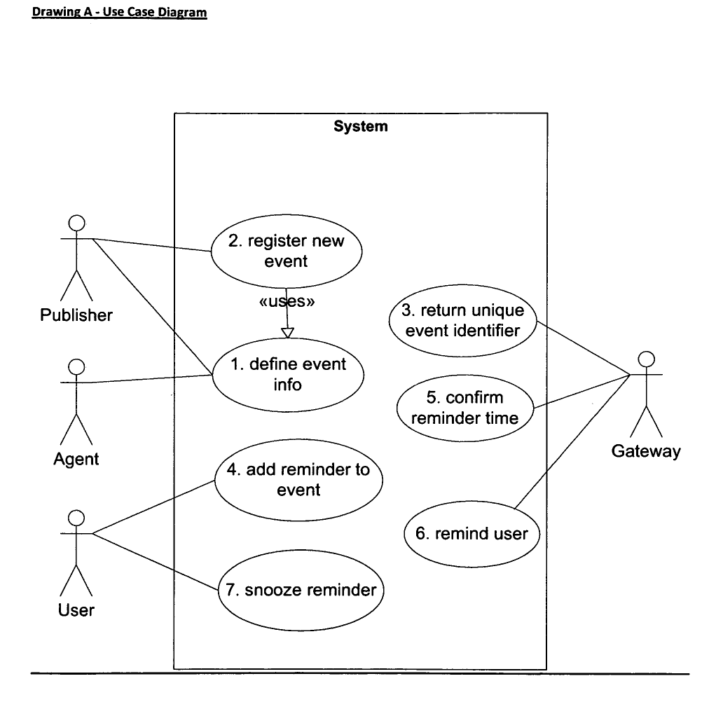

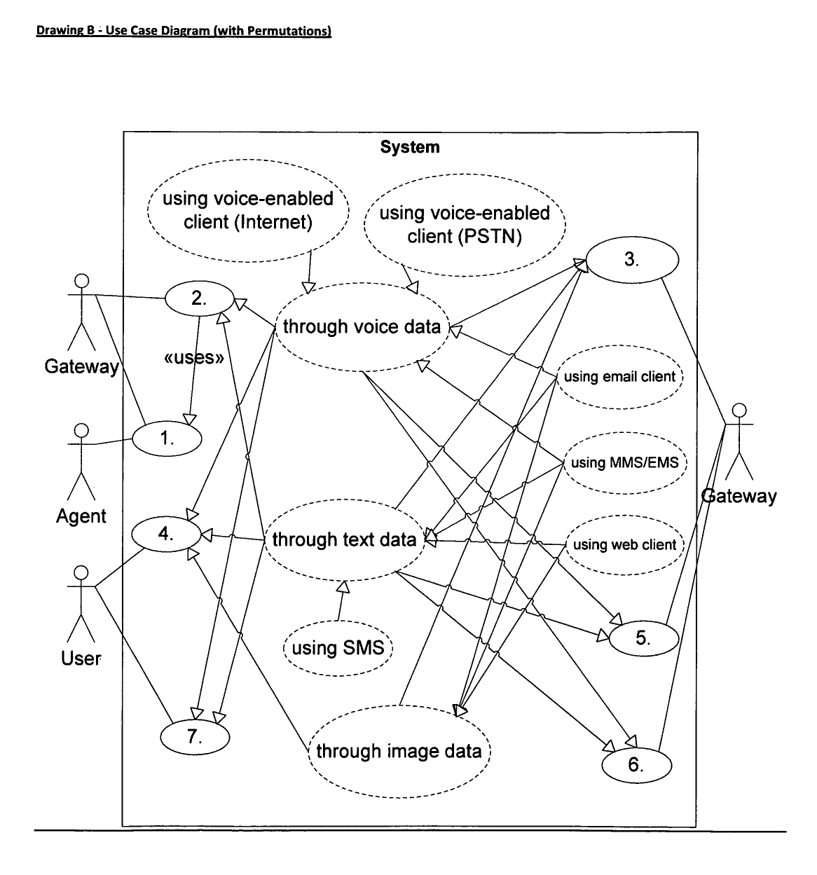

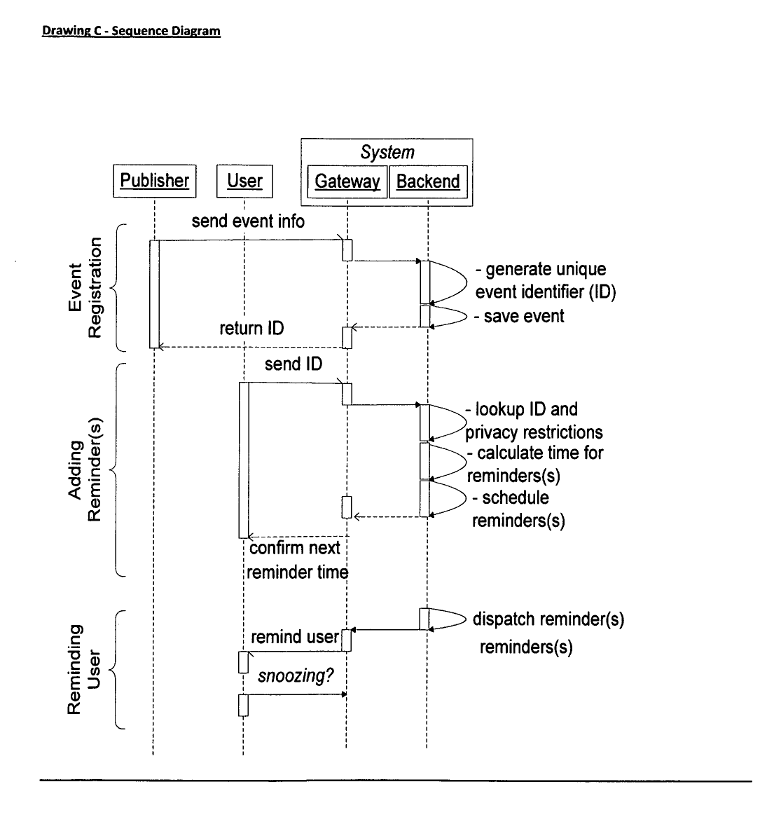

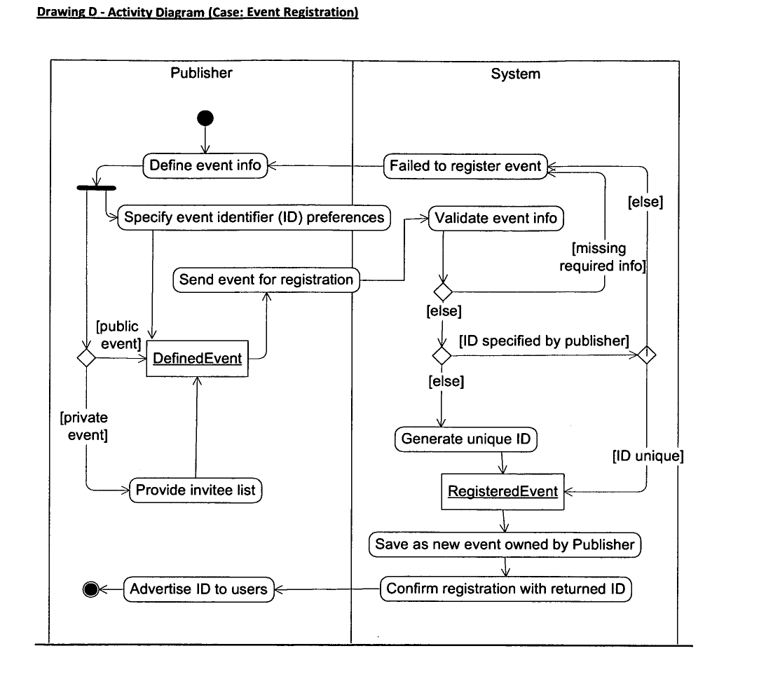

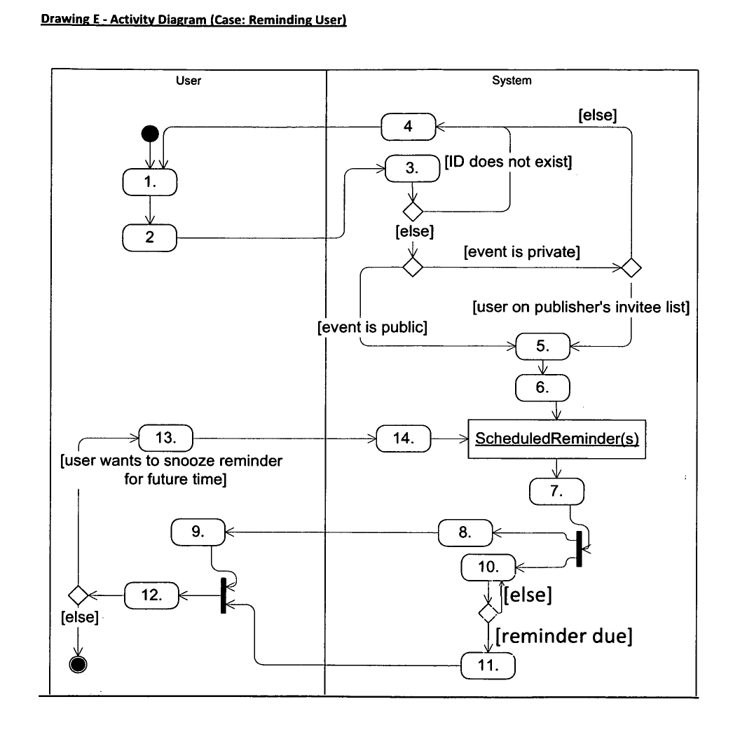

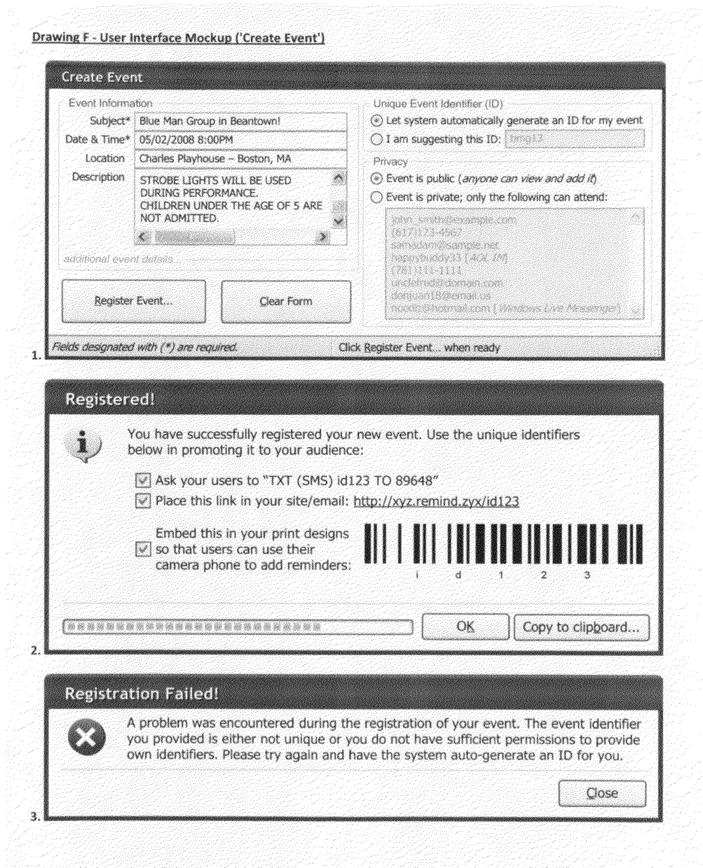

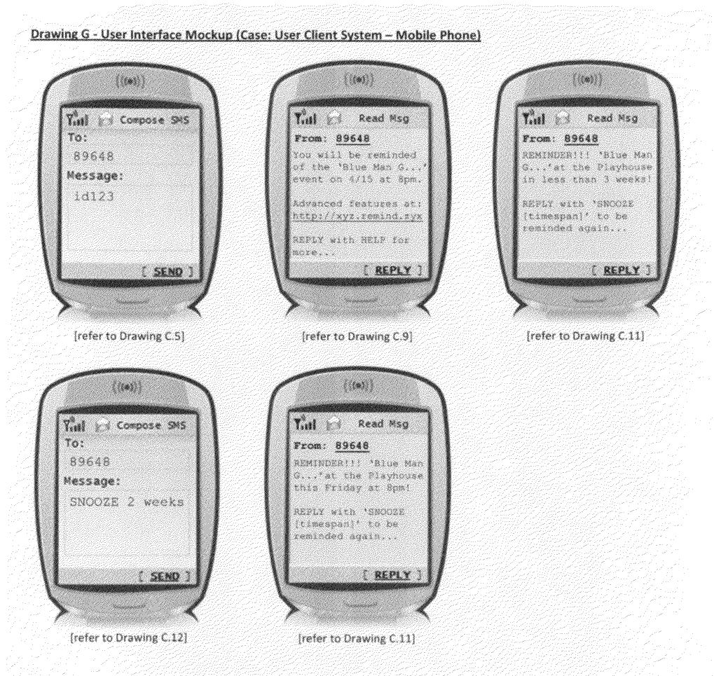

### CROSS REFERENCE TO RELATED APPLICATION

The present application claims benefit of filing date of co-pending Provisional Patent Application # 61/086,007, entitled “System and method for providing electronic reminders”, filed on Aug. 4^{th}, 2008. The first of the PPA reads as follows: “A system and method is disclosed for electronically registering an event and reminding interested persons of the said event.”

### FIELD OF INVENTION

The invention relates to systems that handle electronic reminders of events of interest.

### BRIEF DESCRIPTION OF THE DRAWINGS

For the invention to be more clearly understood, the one or more embodiments thereof will now be described in detail by way of example, with reference to the accompanying drawings, in which:

DRAWING A is a use case diagram showing the different actors and use cases comprised by the disclosed invention;

DRAWING B is a use case diagram that builds further on DRAWING A through highlighting different embodiments of the data types and communication protocols used in transmitting information between the actors;

DRAWING C is a sequence diagram outlining the flow of information between the event publisher and the server system during event registration and then between the server system and end user during the reminder addition and user reminding processes;

DRAWING D is an activity diagram detailing the logical steps and conditions traversed in the process of registering an event with the server system;

DRAWING E is an activity diagram detailing the logical steps and conditions traversed in the process of a user indicating interest to the server system in a registered event and receiving the scheduled reminder once due;

DRAWING F is a schematic abstracting the graphical user interface available on the event publisher's client device for entering event information and registering the event with the server system; and

DRAWING G is a schematic abstracting the graphical user interface available on the user's client device—case of a mobile phone—when expressing interest in an event and receiving its respective reminder from the server system.

### DETAILED DESCRIPTION OF THE INVENTION

An event is any occurrence with a predefined date and time (timestamp). Although the narrative used in describing the invention primarily refers to social events that are of public value and merit being electronically registered by their proprietors for promotion beforehand, this does not preclude the invention from handling any event with a timestamp.

The publisher, creator, sender, host, advertiser, or proprietor of the event will hereinafter be referred to as the event publisher. The user, consumer, recipient, subscriber, or attendee of the event will hereinafter be referred to as the user. Publishers and users will use client systems to interact with the central server system over a telecommunications network. A usage scenario of the invention is a museum (publisher) registering a special exhibition event for which an art fan (user) receives reminders before the event.

In a specific use case of the invention, an event publisher and can be the same person using the same client system to register an event and receive a reminder for it. For example, a person uses a mobile phone to define and register a personal appointment for a future time, hence being the event publisher, and then receives a reminder for the appointment before the event at the same mobile phone, hence also being the user in this illustrative use case.

DRAWING A is a use case diagram showing the different actors and use cases comprised by the disclosed invention. The publisher actor is responsible for defining event information [A1] on the client system and registering it [A2] on the server system. The user actor is any person interested in being reminded of the registered event. The user, through a client system, adds reminders to an event [A4] and, once a reminder is received, can snooze the reminder until a future time [A7].

An agent actor is a computerized event extraction/mining software module that aids the publisher in automatically recognizing and defining event information [A1] on the client system. For example, software on the publisher's computer can process text on a web page being browsed by the publisher and automatically recognize event information described in natural language. The agent would in turn quickly extract pertinent event data fields, such as event time, location, venue, among other fields, and present them to the publisher for registration with the server system. Use of an agent is not necessary; a publisher can always choose to define event information manually.

The gateway actor represents the communication interface on the server system. It receives event information from the publisher and returns a unique event identifier [A3] to the publisher, receives requests to add reminders [A4] from users interested in the event and confirms next reminder times to users [A5], and reminds users of an upcoming event [A6] when the scheduled reminders are due.

While each event is defined and registered by one and only one publisher, it can be added by any number of users (zero or more) to whom the server system gateway will in turn dispatch the pertinent reminder(s) at their scheduled time.

DRAWING B is a use case diagram that builds further on DRAWING A through highlighting different embodiments of the data types and communication protocols used in transmitting information between the actors.

In different illustrative embodiments of the invention, a publisher enters event information textually [B1] in a web-based client system, such as a web page, or in an email and registers it with the server system [B2] over the Internet. The server system gateway would in turn confirm the event registration and return a unique event identifier [B3] to the publisher on web page or in an email respectively. Alternatively, the publisher defines the event in an SMS (Short Messaging Service), sends it to the server system gateway over a cellular network, and receives the unique event identifier back from the server system gateway in another SMS. Alternatively, the publisher uses voice to dictate the event information to the server system gateway over a landline phone, a mobile phone, or using VoIP (Voice over Internet Protocol), and listens to the unique event identifier produced by the server system.

The unique event identifier returned by the server system gateway is a unique combination of alphanumeric characters, a unique graphical identifier, such as a barcode, or any other construct that uniquely identifies the registered event, including a web-based hyperlink or URL (Unique Resource Locator).

A user can become familiar with a registered event and its unique identifier through many media, such as on the web, in an email, in a magazine, on a billboard, on television, or over the radio, among other media. If interested in being reminded of the event, the user attempts to add a reminder for the event [B4] by using a client system to send the unique event identifier to the server system gateway.

Different illustrative embodiments of a user adding a reminder for an event of interest [B4] are entering its unique identifier on a web page served by the server system, in an email sent to the server system gateway, in an SMS sent to the server system gateway from a mobile phone, through dictating the identifier to the server system using a voice-enabled client system (such as phone), through a picture of the event's unique graphical identifier (such as a barcode) sent to the server system gateway in an MMS (Multimedia Messaging Service) from a camera-enabled mobile phone or as an email attachment, among others.

Upon the successful addition of a reminder, the server system gateway sends a confirmation message with the timestamp of the scheduled reminder [B5] to the user at the client system used by the user to add the reminder [B4].

When the reminder is due, the server system gateway dispatches the scheduled reminder to the user [B6]. In deciding which client system to send the reminder to, and unless explicitly configured otherwise by the user, the server system gateway uses as destination for the reminder the source address of the client system or device used by the user to add the reminder, such as a mobile phone number or email address, among others.

Upon receiving a reminder, the user may opt to snooze the reminder [B7] for a specific interval of time by resending the event's unique identifier to the server system gateway along with the desired snooze interval. The server system treats this like a new reminder addition request for the same event of interest and proceeds to confirm the reminder [B5] and dispatch it when due [B6].

While only persons who have signed-up with the server system can publish events, any person using a client system that can communicate with the server system gateway can add a reminder to a registered event and become a first-time user without having to sign-up with the server system. However, users who sign-up with the server system will have the added capability of configuring how their future reminders are scheduled by the server system (frequency, time, and destination of reminder(s), among other preferences).

Although the illustrative embodiments are as described above ([B2], [B3], [B4], [B5], [B6], and [B7]), this does not preclude the invention from using other data types, client devices, client software applications, and communication protocols.

DRAWING C is a sequence diagram outlining the flow of information between the event publisher and the server system during event registration and then between the server system and end user during the reminder addition and user reminding processes. The illustrative embodiment used herein to describe the diagram will involve a publisher using a web-based client system to define and register an event and a user using a mobile telephone to add and receive reminders for the event.

On a web page served by the server system, the publisher uses a graphical user interface (abstracted in DRAWING F1) to enter information defining a new event and submit it over HTTP (hypertext transfer protocol) to the server system [C1]. After generating a unique identifier for the event [C2], the server system couples that with the event information provided by the publisher and saves a record of the event in the server system's database [C3]. The server system then serves a new web page to the publisher's web browser confirming the successful registration of the event along with the event's unique alphanumeric identifier [C4]. The publisher then promotes the event in a magazine through an advertisement that includes the event's unique identifier.

Upon coming across the event advertisement and being interested in receiving a reminder to the event, a magazine subscriber uses a mobile phone to type the event's unique identifier in an SMS and send it to the server system's CSC (Common Short Code, a special telephone number, significantly shorter and easier to remember than a full telephone number, which can be used to address SMS and MMS messages from mobile phones) [C5].

The server system gateway receives the user's SMS and parses its contents for the unique event identifier. The server system then looks up the unique event identifier extracted from the user's SMS and ensures it exists (matches an event record in the server system's database) and is eligible for reminder addition by the sending user [C6], as some events may be private and restricted to a list of user(s) that is pre-specified by the publisher upon event registration (further described in DRAWINGS D & E). The server system then calculates the optimal reminder time [C7] (further described in DRAWING E) and schedules it for future dispatching by saving a record of the reminder in the database [C8]. The server system gateway then responds with an SMS sent to the user's mobile phone number confirming that a reminder has been successfully added and will be sent to the user at the scheduled time [C9].

As time elapses and the scheduled reminder becomes due, the server system triggers the scheduled reminder [C10] by having the server system gateway send a reminder message in an SMS to the user's mobile phone number [C11].

If the user's mobile phone number is recognized by the server system as that of a signed-up user who has explicitly configured reminder preferences with when, how many, and to which client system(s) future reminder(s) should be sent, the server system uses those preferences in scheduling the user's reminder(s) for the event. If multiple reminders are scheduled, the steps of reminder triggering [C10] and dispatching to user's client system [C11] are repeated for each scheduled reminder.

Should the user snooze a received reminder [C12], the server system treats the user's snooze message as a new reminder addition request for the same event of interest and proceeds to confirm the reminder [C6-C9] and dispatch it when due [C10-C11].

DRAWING G depicts the graphical user interface on the user's mobile phone when adding the reminder [C5], receiving the reminder confirmation [C9], receiving the reminder [C11], snoozing the reminder [C12], and receiving the snoozed reminder [C11].

DRAWING D is an activity diagram detailing the logical steps and conditions traversed in the process of registering an event with the server system. The description of this diagram will focus on aspects of the invention that have not been detailed in DRAWINGS A, B, & C.

In defining the event information, eligible publishers may opt to specify on the client system their own unique event identifier [D2], which, upon registration, will in turn be validated by the server system for uniqueness and for publisher eligibility to specify own identifier [D5]. For example, a publisher-specified unique event identifier may be desired by a premium or paying publisher to provide users with an event identifier that is more legible, easier to remember, and/or more readily associated with publisher's brand/name than one that is randomly generated by the server system. If a unique event identifier is not provided by the publisher or the publisher is ineligible to provide own identifiers, the server system generates a random, unique event identifier for the new event [D7].

In defining the event information, the publisher designates the event as public or private [D3], whereby a reminder to a public event can be added by any user, whereas a private event needs an explicit invitee list of eligible user addresses (such as user email address, telephone numbers, among others) specified by the publisher, against which all users attempting to add a reminder to the said private event will be checked (as shown in DRAWING E).

DRAWING E is an activity diagram detailing the logical steps and conditions traversed in the process of a user indicating interest to the server system in a registered event and receiving the scheduled reminder once due. The description of this diagram will focus on aspects of the invention that have not been detailed in DRAWINGS A, B, C, & D.

After the server system ensures that the unique event identifier received from the user is of the valid format, exists in the server system's database, and is associated with an event that takes place at a future time (after the time of attempting to add the reminder) [E3], the server system checks to see if the sending user is eligible for adding a reminder to the said event. If the event has been designated as public by its publisher, then any user can add a reminder to the said event. If the event has been designated as private by its publisher, then the user's client system address (such as email address or mobile phone number, among others) must be on the invitee list of eligible user addresses specified by the publisher for the said user to be able add a reminder to the private event.

In calculating the optimal time to schedule reminders, the server system factors in the user's interaction history and any explicit reminder preferences set previously by a signed-up user [E5], in addition to system-wide rules and heuristics based on statistical analysis of all users' history. Those factors will constitute parameters in an algorithm used by the server system's reminder scheduling module, which will decide the number of reminders scheduled for a user per event, the time each reminder is scheduled for delivery, the format each reminder is delivered in, and the client system and device to which each reminder is delivered [E6].

In an illustrative embodiment of how the reminder scheduling algorithm works, a first-time user attempting to add a reminder to an event that will take place in X days using a mobile phone will result in one reminder sent to the user at the same mobile phone number in X/2 days (calculated as midway time between the event's time and the time the reminder was added by the user), rounded to the closest business hour in the user's time zone. If the event was taking place at a much later date (in Y months), more than one reminder will be automatically scheduled by the system to help alert the user of the nearing event at increasingly narrower intervals leading up to the event. If the event was categorized by its publisher as actionable, such as a birthday or a concert, hence possibly requiring the user to take action ahead in time to buy a birthday gift or ticket to the concert, the server system's reminder scheduling module will account for this information when scheduling reminders to ensure enough lead-time is given to the user to prepare for the event of interest.

In an alternative embodiment, a signed-up user can configure future reminders added for events published by a certain favorite publisher or categorized in a certain category of interest to be scheduled more frequently or to be received on carryon client systems, such as a mobile phone rather than email, which would reserved for other publishers or event categories.

In an alternative embodiment, the server system's reminder scheduling module can use statistical data aggregating the reminder preferences of all signed-up users to heuristically affect the frequency and scheduling time of future reminders added by new users who have not signed-up.

While only a few embodiments of the algorithm used by the server system's reminder scheduling module have been described, this does not preclude other rules, heuristics, data points, and parameters to be used by the algorithm to schedule optimal reminders for users.

DRAWING F is a schematic abstracting the graphical user interface available on the event publisher's client system for entering event information and registering the event with the server system. While only a subject and timestamp are required for the registration of a new event, publishers typically enter additional information to describe an event (such as location map or ticket information) [F1]. Upon successfully registering an event, the publisher receives the event's unique identifier in various formats [F2]. If the publisher is ineligible to provide own event identifier or the provided identifier is not unique, the server system signals a failed event registration message to the publisher [F3].

DRAWING G is a schematic abstracting the graphical user interface available on the user's client device—case of a mobile phone—when adding a reminder to an event and when receiving the due reminder from the server system. The server system's scheduling module formats reminders sent to different client systems differently. For example, a concise reminder message limited to essential event information is sent to a user's mobile phone (due to the device's relatively smaller display and to the 160-character per SMS limit), whereas a reminder sent as an email to the user would contain additional event information. A user who has signed-up with the server system, for instance, can have the reminder preferences configured to deliver rich-format email reminders that contain HTML elements and embedded, event-related pictures, while another user may prefer email reminders delivered in plain text.

### Drawing B—Legend

1. Define event info
2. Register new event
3. Return unique event identifier
4. Add reminder to event
5. Confirm reminder time
6. Remind User
7. Snooze reminder

### Drawing E—Legend

1. Capture ID from event of interest
2. Send ID to add reminder
3. Lookup event info from ID
4. Failed to register event
5. Check user history and pre-set reminder preferences
6. Calculate date and time of new reminder(s) based on system rules and heuristics
7. Save as new user reminder(s) for event with received ID
8. Notify user of scheduled time for next reminder
9. Anticipate reminder to event of interest at confirmed time
10. Wait until scheduled reminder due
11. Send reminder to user at appropriate destination
12. Receive reminder
13. Send snooze interval
14. Create new reminder

What is claimed is:

1. A method for providing electronic reminders comprising:
under control of a first client system,
entering and sending event information, and generating a unique identifier for said event; and
under control of a second client system, using said unique event identifier to express interest in said event and receive one or more reminder messages; and
a server system in communication with first client system and second client system, the server system including means for storing event information, means for storing event unique identifier, means for storing reminder messages, means for sending reminders to the second client device.

2. The method of claim 1 wherein the event information is entered in a browser.

3. The method of claim 1 wherein the event information is entered in an email.

4. The method of claim 1 wherein the event information is entered in a wireless Short Message Service (SMS) message.

5. The method of claim 1 wherein the event information is entered in a wireless Multimedia Messaging Service (MMS) message.

6. The method of claim 1 wherein the event information is entered in an Instant Messaging Application (IM).

7. The method of claim 1 wherein the event information is entered by the speaking of a sound.

8. The method of claim 1 wherein the event unique identifier is a string of alphanumeric characters.

9. The method of claim 8 wherein the event unique identifier is a number.

10. The method of claim 8 wherein the event unique identifier is a string of alphabetical characters.

11. The method of claim 1 wherein the event identifier is a unique graphical pattern.

12. The method of claim 11 wherein the event identifier is a barcode.

13. The method of claim 1 wherein the event unique identifier is a digital picture.

14. The method of claim 1 wherein the user enters the unique event identifier in a browser.

15. The method of claim 1 wherein the user enters the unique event identifier in an email.

16. The method of claim 1 wherein the user enters the unique event identifier in a wireless Short Message Service (SMS) message.

17. The method of claim 1 wherein the user enters the unique event identifier in a wireless Multimedia Messaging Service (MMS) message.

18. The method of claim 1 wherein the user enters the unique event identifier in an Instant Messaging Application (IM).

19. The method of claim 1 wherein the user enters the unique event identifier by the speaking of a sound.

20. The method of claim 1 wherein the first client system is with means of communicating with the server system using a telephony network, and wherein the second client system is with means of communicating with the server system using a telephony network.

21. The method of claim 1 wherein the first client system is with means of communicating with the server system using the Internet, and wherein the second client system is with means of communicating with the server system using the Internet.

22. The method of claim 1 wherein the reminder is dispatched to the user on a browser.

23. The method of claim 1 wherein the reminder is dispatched to the user in an email.

24. The method of claim 1 wherein the reminder is dispatched to the user in a Short Message Service (SMS) message.

25. The method of claim 1 wherein the reminder is dispatched to the user in a wireless Multimedia Messaging Service (SMS) message.

26. The method of claim 1 wherein the reminder is dispatched to the user in an Instant Messaging Application (IM) message.

27. The method of claim 1 wherein the reminder is dispatched by the playing of a sound.

28. A system for scheduling electronic reminders for an event with means to determine the number of reminder messages for an event,
the dates and times on which the reminders are dispatched, and
the communication channels through which the reminder messages are dispatched,
based on said event information comprising the time, date, location, and/or nature of the said event.
